(19) United States
(12) Patent Application Publication
(10) Pub. No.: US 2008/0288370 A1
(43) Pub. Date: Nov. 20, 2008

(54) Business Method and System Related to a Fashionable Items Utilizing Internet

(76) Inventors: Jong Hae Kim, Seoul (KR); Kyong Ja Han, Seoul (KR); Jay Jihae Kim, Northridge, CA (US); David Hyuntae Kim, Los Angeles, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 12/093,105

(22) PCT Filed: Nov. 10, 2006
(86) PCT No.: PCT/KR2006/004687

§ 371 Date: May 8, 2008

(30) Foreign Application Priority Data
Nov. 10, 2005 (KR) 10-2005-0107406

(51) Int. Cl. G06Q 30/00

(52) U.S. Cl. 705/27

(57) ABSTRACT

A method and system of B2C e-commerce for placing an order to purchase fashionable items for minimizing the return rate after selling via the Internet. The order is placed by a first banner window at seller's website for displaying a prerecorded digital video image of a model of the same or similar size of the buyer wearing the clothes that the buyer wants to purchase, and a second banner window for displaying a static digital image of the model for synthesizing the face of model, hair patterns, foot-wear or accessories such as necklace, earrings, hairpin, or sunglasses selected by the buyer from the database of the system. This provides a technology to reduce the return rate by checking the fashionable products whether suitable with the figure and face image of the buyer before placing an order through a cyber fashion show and synthesizing the image for confirming coordination.

### FIELD OF INVENTION

This invention relates to provide a method and system of B2C e-commerce for minimizing the return rate of fashionable items after selling through Internet with a first banner window for displaying a prerecorded digital video image of a model of the same or similar size of the buyer wearing the clothe that the buyer want to purchase, and a second banner window for displaying a static digital image of the model for synthesizing the face of model, hair patterns, foot-wears or accessories such as necklace, earrings, hairpin, or sunglasses that selected by the buyer from the database of the system.

Accordingly, this invention provides a technology to check the clothes by the view at every direction that the buyer want to see by controlling the playing speed of the prerecorded video image or displaying the pictures by flame by a form of slide show.

Another objects of this invention are to provide a system that the buyers synthesize the model with the image of their face or the hair style from the various patterns which stored in the database, for confirming coordination with the clothe selected by the buyer and print out or transmit the selected image file to a beauty salon of the buyer's choice.

Additionally, the synthesizing technology of various accessories from the database of the system at the separated banner window is providing the buyer a fun to play in the cyber look by matching clothes, with various hair patterns, foot-wears or accessories and it will boost this e-commerce business especially from the young generation.

### BACKGROUND OF THE INVENTION

The conventional method to selling clothes by Internet is mainly displaying the clothes in two-dimension photo or pictures of an ideal figured model who is wearing the clothe and mostly displays in front surface, and it makes problems for increasing the return rate after the buyer purchases the clothes in the Internet look since buyers can not check every details how it looks during moving and unsatisfied the products. Also, the image on the conventional method displays the model based on an ideal of figure in displaying so that the buyers cannot distinguish whether it is suitable for their own figure and face to avoid said problems.

The 3D animation technologies to display clothes or models wearing clothes were developed however the cost is extremely higher for synthesizing the figure with various clothe size and the face of each user as well as complementation of 3D animation of the various products of the thousands kind.

### THE SUMMARY OF THE INVENTION

The problem and limitation of the known and described systems of the background of this invention are overcoming by the principles of the present invention whereby. This invention comprises two kinds of tools for selecting fashionable products such as clothes and accessories by Internet. The tools are comprising the first banner window for displaying the actual digital video image of the model whose size is the same or the similar as the buyer, wearing the clothe which the buyer want to purchase, and the second banner window in addition to the first banner window, for displaying the actual digital static image of the full size figure of said model for synthesizing the face of the model, hair design, footwear, or accessories such as a necklaces, earrings, a hairpin, or sunglasses that selected from the database of the present system or the database of the suppliers of each product.

Thus, this invention provides a technology for the buyers to select the clothe with the first banner window by controlling the playing speed of the prerecorded video image or by slide show of each flame, and by confirming the coordination of the buyer with the face, the cloth, the hair style or the various accessories whether they are suitable for the figure and face of the buyer oneself with the second banner window.

### ADVANTAGEOUS EFFECTS

The present Invention provides the useful technologies, which remarkably reduces the returning rate of the goods since the buyers selected the goods after careful checking with the real model of their size, even synthesizing the face, the hair design or the various accessories whether they are suitable for the figure and face of the buyer oneself.

Also this invention provides the most economical solution to find the most suitable clothe or accessories comparing its own figure and face of the buyer in Internet look by synthesizing at the banner window.

### BRIEF DESCRIPTION OF THE DRAWING

FIG. 1 is a detailed block schematic diagram of the present invention.

### DETAILED DESCRIPTION OF THE PREFERRED EMBODIMENTS

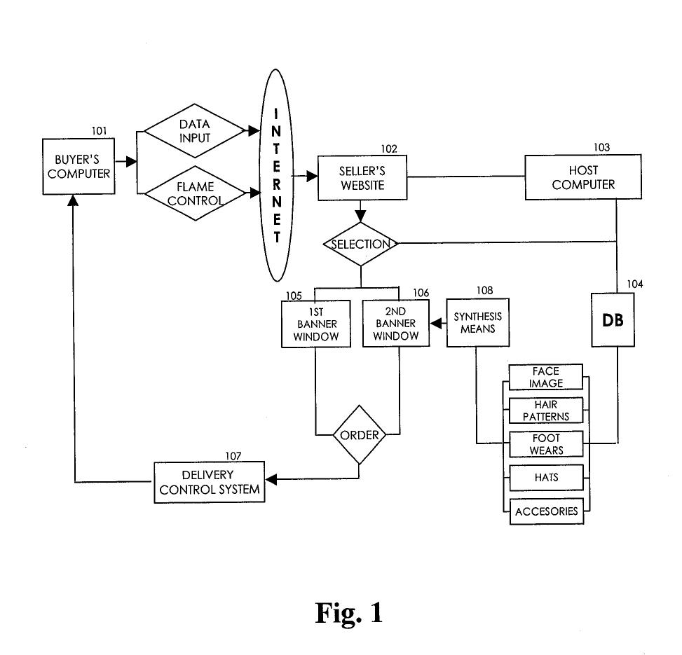

Hereinafter, this invention describes the functional operation according to the system configuration of the present invention for achieving the described object. The FIG. 1 is illustrating the system configuration diagram of the present invention. Referring to the FIG. 1, the system of the present invention is comprising a plurality of buyer's web terminal computer (101) for ordering and inputting a physical data of the buyer such as a face image, a size of the clothe or size of height, girth, waist and hip to a host computer of the seller's site, a database (104) of digital video image of models who are wearing clothes to sell according to the specified standard clothe sizes and demonstrating to show the every view of the product by motion and a data of hair patterns, foot-wears, hats or accessories, a host computer (102) for displaying a video image of specific model wearing the selected clothe by size or the data inputted by the buyer on the first banner window (105), and a still image of the model in full size on the second banner window (106) at the same time, and a means (108) for synthesizing image on the second banner window with the data of the face of buyer, the hair patterns, the hats, the foot-wears or accessories from the database of the system, coupled with the host computer.

This system may also stores a plurality of still pictures instead of digital video file for displaying the image on the first banner window in slide show by controlling the speed of displaying pictures at the first banner window by a control means coupled to the host computer.

Further, this system may comprise an editing means in addition to the means for synthesizing for editing the picture on the second banner window, for enlarging or reducing of the picture flame by designating the part of the picture for editing, changing the color of the products or printing out the synthesized static images. The above effect can be obtained even the digital video image on the database is substituted by the image of 3D animation instead of the actual model by size according to the products.

The method for placing on order and selling an item of the present invention is comprising the step of (a) storing a data of digital video image of models of each clothe size wearing clothe according to the specified standard size and demonstrating to show the every view of the product, and a data of a hair pattern, a foot wears, a hat or accessories on the database (104), (b) inputting physical data of the buyer such as a face image, a size of clothe or a size of height, girth, waist and hip to a database (104) under control of a host computer (103) of the seller's site by a buyer's terminal computer (101), (c) designating a signal to select the clothe on the seller's site from the buyer's terminal computer (101), (d) displaying a video image of the specific model wearing the selected clothe according to the size of the buyer on the first banner window (105) and a still image of the model in full size on the second banner window (106) at the same time by the host computer, and (e) selecting the clothe by controlling the speed of the video image motion on the first banner window and by synthesizing on the second banner window with the data such as the hair pattern, the hat, the foot-wears, accessories or the buyer's face image from the database (104) for checking coordination of the clothe, This system may further comprise the step for displaying a slide show in various flame alteration speeds by a control means coupled to the host computer and the step for editing at the second banner window by enlarging or reducing the picture flame by designating the part of the picture according to a designation signal, changing color, or printing out by an editing means coupled to the host computer. It may also configured not to synthesize the face image of the buyer on the second banner window and displaying the face image of the model of the first banner window and it may synthesize on the second banner window with a data from a database of each supplier's site of the hair patterns, the foot-wears or the accessories instead of the database (104) of the system.

It optionally varies the frame alteration time of a screen. The host computer gets to display with the means which optionally controls the number of the frame comprising the image operation of being exposed of a model on the first banner window which displays to the moving picture to the form of a slide show and it varies the speed of the slide show or stop to observe with a certain frame. Moreover, in the second banner window exposing the front side static images of a model, the host computer synthesizes the face of a buyer according to the selection signal of a buyer by means of a Photoshop with the style pattern of a hair, footwears, or accessories, which is selected in the database of the site. The segment of the still image can be exposed according to the software program that is set up in the host computer.

Also, the settlement system of profit model and delivery system may quote the various system description of preexistence.

For example, if a plurality of independent sellers are displaying their products on this system, they have to make a contract with the site operator of this system, and buyers remits the price of the goods to a bank account of the site operator for setting accounts with the sellers after checking the delivery of goods to the buyer. In this case the profit model will be the margin or the commission that the site operator is changing when setting accounts with sellers. This system may solve the non-delivery problems between the seller and the buyer and make easy for setting returning argues since it reserve the price of goods until expiring the legal returning period.

The contents described in the invention can be improved according to progress and development of each elemental technology. The technology of the comparison of image and audio data for the first banner window of the present invention may be adopted any of the present standard of MPEG 1, 2, 4, 7 or common media language such as DivX as well as a flash tool such as a Macromedia (FH9, FH10) or Adobe illustrator (EPS, A1 format) for animation.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of e-commerce for selling fashionable products by Internet through a seller's website comprising the step of,
(a) storing a data of digital video image of models of each clothe sizes who are wearing clothes according to the specified standard clothe size and demonstrating to show the every view of the product, and a data of a plurality of hair patterns, foot wears, hats or accessories, to a database of the seller's website,
(b) inputting physical data of the buyer such as a size of clothe or a size of height, girth, waist and hip and/or a digital data of buyer's face image to a host computer of the seller's website by a buyer's terminal computer,
(c) designating a signal to select the clothe on a catalogue of the seller's website from the buyer's terminal,
(d) displaying a video image of specific model who is wearing the selected clothe according to the physical size of the buyer on the first banner window and a still image of the model in full size on the second banner window at the same time by the host computer of the seller's website,
(e) selecting the clothe by controlling the speed of the video image motion on the first banner window and by synthesizing on the second banner window with the data such as the buyer's face, the hair pattern, the hat, the foot-wears or the accessories from the database of the seller's website for checking coordination of the selected clothe, and
(f) ordering the selected products according to the order formalities set by the seller's website.

2. The method of claim 1, wherein the step for storing the digital video image files, stores a plurality of still pictures instead of video image and displaying a slide show in various speeds by a control means coupled to the host computer.

3. The method of claim 1, wherein the step for displaying, displays the face image on the second banner window without synthesizing with the data of buyer's face image and displays the face image of the model of the first banner window.

4. The method of claim 1, wherein the step for displaying synthesizes on the second banner window with a data such as hair patterns, foot-wears, or accessories from a database of each supplier's website.

5. The method of claim 1, further comprising the step for editing at the second banner window by enlarging or reducing the picture flame by designating the part of the picture according to a designation signal, changing color, or printing out by an editing means coupled to the host computer.

6. A system of e-commerce for selling fashionable products by Internet through a seller's website comprising,
(a) a plurality of buyer's web terminal computer for inputting a physical data of the buyer such as a size of the clothe or size of height, girth waist and hip, or a digital image file of a buyer's face to a host computer of the seller's site,
(b) a database of a digital video image or a plurality of still pictures of models wearing clothe according to the specified standard clothe size and demonstrating to show the every view of the product, and of a data of hair patterns, foot-wears, or accessories,
(c) a host computer for displaying a video image of specific model wearing the selected clothe by size of the buyer on the first banner window, and a still image of the model in full size on the second banner window at the same time, and
(d) a means for synthesizing image on the second banner window with the data file of the face of buyer, the hair patterns, the foot-wears, or accessories from the database of the system, coupled with the host computer.

7. The system of claim 6, further comprising a control means coupled to the host computer for displaying the image in slide show instead of video motion and controlling the speed of displaying.

8. The system of claim 6, further comprising an editing means for enlarging or reducing of the picture flame by designating the part of the picture according to a designating signal on the second banner window, changing color of the products, printing out or sending data to the designated terminal.

9. The system of claim 6, wherein the host computer further controls for displaying the model wearing the product on the first banner window and the second banner window in the image figure of animation with a means for editing the image.
